(19) United States
(12) Patent Application Publication
(10) Pub. No.: US 2010/0289227 A1
(43) Pub. Date: Nov. 18, 2010

(54) SEALING DEVICE FOR AN ARTICLE HANDLING MACHINE

(76) Inventor: Michele Soncini, Octeville Sur Mer (FR)

Correspondence Address: SUGHRUE MION, PLLC, 2100 PENNSYLVANIA AVENUE, N.W., SUITE 800, WASHINGTON, DC, 20037, US

(21) Appl. No.: 12/741,323

(22) PCT Filed: Nov. 7, 2007
(86) PCT No.: PCT/IB07/04268

§ 371 Date: Jul. 27, 2010

(51) Int. Cl. F16J 15/46

(52) U.S. Cl. 277/646

(57) ABSTRACT

Sealing device (11) for sealingly interfacing two adjacent blocks (2, 3) of an article handling machine, each provided with an aperture (6, 9), said sealing device (11) comprising a resilient static sealing joint (12) mounted along the edge (7) of one aperture (6), wherein the sealing joint (12) is hollow, and wherein the sealing device (11) further includes an injection valve (14) for injecting air in the sealing joint (12) to inflate it.

### FIELD OF THE INVENTION

The invention relates to a sealing device for sealingly interfacing two adjacent blocks of an article handling machine.

### BACKGROUND OF THE INVENTION

Article handling machines are often manufactured in several parts (called blocks) assembled to form a one-piece manufacturing line.

Such a design (called modular design) is satisfactory because it facilitates transportation of the different blocks (which may come from different manufacturing places) to the final destination where the machine is assembled.

However, assembly of the different blocks may be problematic, especially for handling machines which define a closed inner volume. For example, in the container industry, aseptic filling machines require that the inner volume be isolated from the outer environment to preserve containers from bacteria.

In such a case, sealing joints are generally provided at the interface between two adjacent blocks, around an aperture in the blocks for allowing passage of the articles.

Such a solution seems satisfactory, but leaks are often witnessed in large-sized machines, due to the distortion of the blocks under the stress they undergo during assembly (the ground may not be perfectly planar) and operation (e.g. vibrations may occur) of the machine.

There is therefore a need for improvements in sealing devices provided at the interface between adjacent blocks of an article handling machine.

### SUMMARY OF THE INVENTION

It is an object of the invention to provide a sealing device having increased sealing properties.

It is another object of the invention to provide a sealing device having enhanced reliability.

Accordingly, there is proposed a sealing device for sealingly interfacing two adjacent blocks of an article handling machine, each provided with an aperture, said sealing device comprising a resilient static sealing joint mounted along the edge of one aperture, wherein the sealing joint is hollow, and wherein the sealing device further includes an injection valve for injecting air in the sealing joint to inflate it.

The above and other objects and advantages of the invention will become apparent from the detailed description of preferred embodiments, considered in conjunction with the accompanying drawings.

### BRIEF DESCRIPTION OF THE DRAWINGS

FIG. 1 is a partial perspective view showing a block of an article handling machine provided with a sealing device.

FIG. 2 is a sectional view showing assembly of two blocks interfaced with a sealing device, shown in a non inflated state.

FIG. 3 is a sectional view showing assembly of the blocks of FIG. 2, interfaced with the sealing device shown in an inflated state.

### DESCRIPTION OF PREFERRED EMBODIMENTS

Turning now to the drawings, there is shown a frame element 1 of an article handling machine 2, e.g. a container handling machine. The machine is modular, and therefore built by assembly of several functional blocks 2, 3 (e.g. for supporting a container feeding unit, a container rinsing unit, a container filling unit and a container capping unit) juxtaposed and coupled by means of removable fixation means such as bolts.

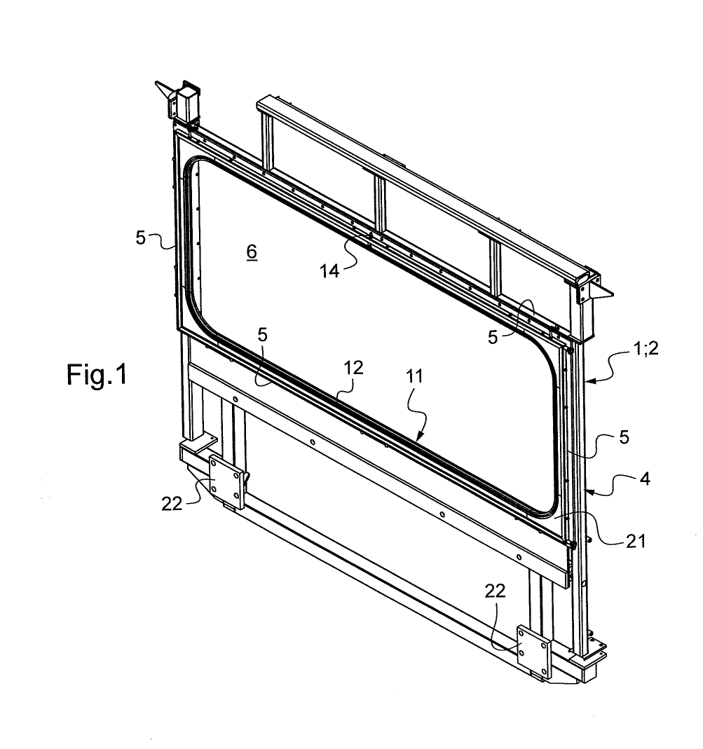

The frame element 1 shown on FIG. 1 is a lateral wall of a machine block 2, ready to be interfaced with one adjacent block 3. The wall 1 comprises an overall chassis 4 formed of welded metallic beams 5 of rectangular or square section.

There is defined in the chassis 4 an aperture 6 through which the articles are to be transferred from one block 2 to the adjacent one 3. In one embodiment, illustrated on FIG. 1, the aperture 6 has a rectangular shape (with rounded corners) and is limited by a rectangular edge 7 defined by a cut-out in a plate 8 fixed to the chassis 4.

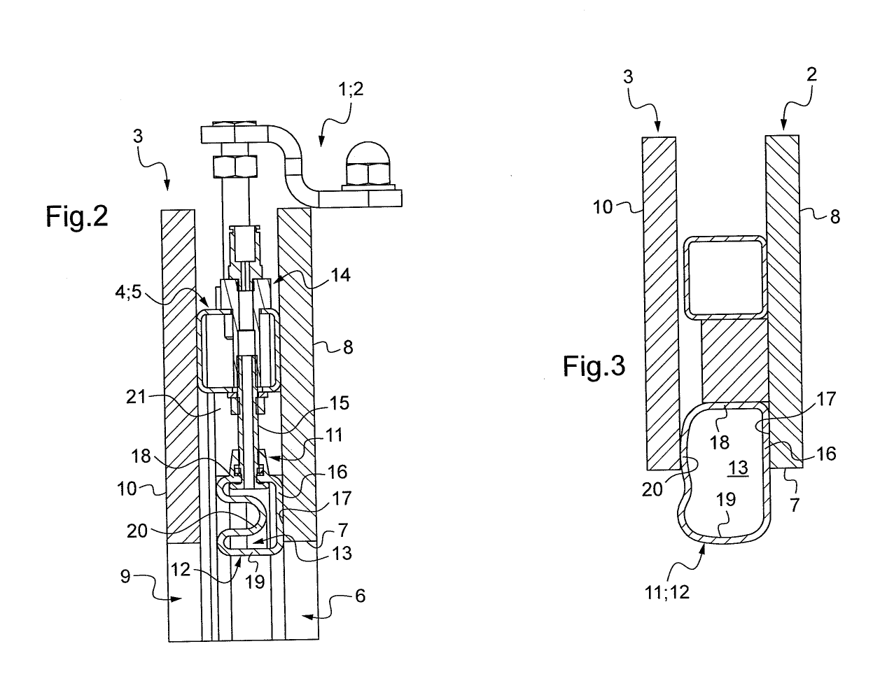

Correspondingly, the adjacent block 3 defines an aperture 9 of similar shape and dimensions, formed by a rectangular cut-out in a plate 10 fixed to a chassis of the adjacent block 3. Once the blocks 2, 3 are assembled, both apertures 6, 9 are coincident, as illustrated on FIG. 2.

As depicted on the drawings, there is provided a sealing device 11 for sealingly interfacing the adjacent blocks 2, 3, mounted on the chassis 4 of the block 2 around the aperture 6.

More precisely, the sealing device 11 comprises a resilient static sealing joint 12, made e.g. of rubber, mounted along the edge 7 of the aperture 6.

The sealing joint 12 is hollow and defines an inner air chamber 13. The sealing device 11 further includes an injection valve 14 for injecting pressurized air (or any equivalent inert gas) in the air chamber 13 to inflate the sealing joint 12.

As depicted on FIG. 2, the injection valve 14 comprises a nozzle 15 attached to the sealing joint 12, for putting the air chamber 13 in communication with a pressure source.

It can be seen on FIG. 2 that, before it is inflated, the sealing joint 12 presents a U-shaped section. It comprises a flat back wall 16, fixed to a planar outer face 17 of the plate 8 (e.g. by means of glue), an outer wall 18 to which the nozzle 15 is attached, an inner wall 19 limiting the aperture 6, and a U-shaped front wall 20 linking the outer wall 18 and the inner wall 19 and protruding inwards into the volume limited by the back wall 16, outer wall 18 and inner wall 19.

The sealing device 11 further comprises a frame 21 fixed to the outer face 17 of the plate 8 and surrounding the sealing joint 12, in contact with the outer wall 17 thereof, to confine the sealing joint 12 when inflated.

As depicted on FIG. 2, the surrounding frame 21 is adjacent the beams 5 of the overall chassis 4, thereby increasing rigidity of the wall 1.

The machine blocks 2, 3 are sealingly assembled as follows.

First, the blocks 2, 3 are placed adjacent to one another, so that the apertures 6, 9 are coincident. The plate 10 of the adjacent block 3 may be in contact with the chassis 4 of the block 2, as depicted on FIG. 2. The blocks 2, 3 are then fixed to one another, e.g. by means of fixation bolts inserted in holes provided in coupling plates 22. Once the blocks 2, 3 are fixed together, pressurized air is injected via the nozzle 15 in the air chamber 13, so that the sealing joint 12 is inflated, until the front wall is bent outwards to a point where it exerts on the plate 10 of the adjacent block 3 a pressure all around the aperture 9 (FIG. 3), thereby sealing the interface between the blocks 2, 3. Under the pressure of the sealing joint 12, the adjacent block 3 may be slightly spaced from the chassis 4, as depicted on FIG. 3.

The back wall 16 and outer wall 18 remain still, since they are confined by the plate 8 and the surrounding frame 21, respectively, so that only the inner wall 19 and front wall 20 are bent, thereby conferring the sealing joint 12 the general shape of a bean (FIG. 3).

Value or the air pressure in the air chamber 13 is left to the appreciation of the skilled person. Pressures comprised between 2 and 4 bars seem convenient in most applications.

The sealing joint 12 is preferably made of silicon, and has a wall thickness e.g. in the range of 2-5 mm.

Accordingly, there is provided a sealing device allowing good and reliable performance for interfacing two blocks in article conveying machines.

Of course, the invention is not limited to the disclosed embodiments. In particular, the skilled person may adapt the shape of the sealing joint 12 to the edge of the aperture 6, and/or the section of the sealing joint 12 to the surfaces on which it is provided to exert a pressure.

1. Sealing device for sealingly interfacing two adjacent blocks of an article handling machine, each provided with an aperture, said sealing device comprising a resilient static sealing joint mounted along the edge of one aperture, wherein the sealing joint is hollow, and wherein the sealing device further includes an injection valve for injecting air in the sealing joint to inflate it.

2. Sealing device according to claim 1, wherein, before inflated, the sealing joint has a U-shaped section.

3. Sealing device according to claim 1, wherein the sealing joint is fixed to a planar surface of one block, adjacent said aperture.

4. Sealing device according to claim 3, wherein the sealing joint is glued to said planar surface.

5. Sealing device according to claim 1, further comprising a frame surrounding the sealing joint.

6. Sealing device according to claim 5, wherein the frame is fixed to one block.

7. Sealing device according to claim 1, wherein the injection valve comprises a nozzle for putting an inner volume of the sealing joint in communication with a pressure source.

8. Sealing device according to claim 7, wherein said nozzle is fixed to an outer wall of the sealing joint.
